(19) United States
(12) Patent Application Publication
(10) Pub. No.: US 2011/0135943 A1
(43) Pub. Date: Jun. 9, 2011

(54) ANTICORROSIVE COATING COMPOSITION AND ANTICORROSIVE COATING STRUCTURE USING SAME

(75) Inventors: Michiaki Kinoshita, Tokyo (JP); Shintaro Yamauchi, Tokyo (JP); Jun Kanayama, Tokyo (JP); Kunihiro Kuroki, Tokyo (JP)

(73) Assignee: SHOWA DENKO K.K., Minato-ku, Tokyo (JP)

(21) Appl. No.: 13/058,291

(22) PCT Filed: Aug. 17, 2009
(86) PCT No.: PCT/JP2009/064395

§ 371 Date: Feb. 9, 2011

(30) Foreign Application Priority Data
Aug. 21, 2008 (JP) 2008-212754

(51) Int. Cl. B32B 13/12; C09D 5/08; C08K 3/40; B32B 21/08; B32B 15/09

(52) U.S. Cl. 428/446; 524/604; 524/494; 428/537.1; 428/458

(57) ABSTRACT

The problem to be solved by the present invention is to provide an anticorrosive coating composition which has more alcohol resistance than conventional vinyl ester resins including glass flakes, and is economically effective. In order to solve the above problem, an anticorrosive coating composition including (A) an unsaturated polyester resin composition including (i) an unsaturated polyester obtained from a dibasic acid component and a polyalcohol component and (ii) a polymerizable unsaturated monomer; and (B) a scale-like glass, wherein the dibasic acid includes 70 to 100 mol % of an unsaturated dibasic acid and 0 to 30 mol % of a saturated dibasic acid, and the polyalcohol component includes 50 to 100 mol % of a glycol having a carbon atom number of 1 to 3 in the main chain and a side chain number of 0 or 1, is provided.

### TECHNICAL FIELD

The present invention relates to an anticorrosive coating composition excellent in alcohol resistance and an anticorrosive coating structure using same.

### BACKGROUND

Recently, the amount of carbon dioxide emissions has increased on a global scale, and global warming caused thereby has become a serious problem. Use of alcohol fuels, especially ethanol has been promoted so as to reduce the amount of carbon dioxide emissions derived from fossil fuels in foreign countries. In Japan, it is expected that a fuel for automobiles comprising gasoline having mixed therein ethanol in an amount approximately 10% with respect to gasoline would be used in the future.

Alcohols including ethanol used as fuels are generally stored in a tank or the like made of a metal. However, these alcohols easily absorb water, and there has been a problem that metals such as carbon steel, iron and the like are susceptible to corrosion.

In a method for preventing corrosion, unsaturated polyester resins, vinyl ester resins and the like have been used. In particular, regarding the vinyl ester resins, an anticorrosive coating thereof to which glass flakes are added has been used as an inner coating of outside storage tanks, and excellent anticorrosive properties thereof has been recognized.

However, these resins do not exhibit sufficient resistance to recently developed alcohol-based fuels, and as disclosed in the following non-patent literature publications, it is likely that the level of resistance thereof to gasoline is low, compared to the resistance of conventional resins. In particular, it was confirmed as disclosed in Non-Patent Literature Publication 2 that degradation of unsaturated polyester resin by alcohol occurs, due to the transesterification reaction of a saturated dibasic acid moiety. Before use of resins in which alcohol resistance is required, sufficient studies on them have become necessary.

### PRIOR ART REFERENCES

### Non-Patent Literature Publication

Non-Patent Literature Publication 1: “Reinforced Plastics” (Vol. 53, No. 11, 2007), from page 478 to page 481, published by Japan Reinforced Plastics Society
Non-Patent Literature Publication 2: Journal of the Japan Society for Materials, 18, 2 (1992), from page 66 to page 72

### SUMMARY OF THE INVENTION

### Problems to be Solved by the Invention

Consequently, the present invention was made, considering the above situation, and the object of the present invention is to provide an anticorrosive coating composition which has more alcohol resistance than conventional vinyl ester resins comprising glass flakes, and which is economically effective.

### Means for Solving the Problems

The inventors of the present application keenly studied to solve the above problems, and as a result found that the above problems can be solved by adding scale-like glass to an unsaturated polyester resin composition comprising an unsaturated polyester obtained by the esterification reaction of a dibasic acid component comprising 70 to 100 mol % of an unsaturated dibasic acid and 0 to 30 mol % of a saturated dibasic acid with a polyalcohol component comprising 50 to 100 mol % of a glycol having a carbon atom number of 1 to 3 in the main chain and a side chain number of 0 or 1 to complete the present invention.

### Effect of the Invention

According to the present invention, an anticorrosive coating composition which has more alcohol resistance than conventional vinyl ester resins comprising glass flakes and is economically effective can be provided.

### MODE FOR CARRYING OUT THE INVENTION

The anticorrosive coating composition comprising an unsaturated polyester resin composition and a scale-like glass of the present invention will be specifically explained below.

### <Unsaturated Polyester>

The unsaturated polyester resin composition of the present invention comprises, as essential components an unsaturated polyester obtained by the esterification reaction of a dibasic acid component which comprises 70 to 100 mol % of an unsaturated dibasic acid and 0 to 30 mol % of a saturated dibasic acid, preferably a dibasic acid component consisting of an unsaturated dibasic acid, with a polyalcohol component which comprises 50 to 100 mol % of a glycol having a carbon atom number of 1 to 3 in the main chain and a side chain number of 0 or 1, and a polymerizable unsaturated monomer.

The unsaturated polyester (i) used in the present invention is obtained by the esterification reaction of a dibasic acid component comprising an unsaturated dibasic acid, and as necessary a saturated dibasic acid with a polyalcohol component comprising a specific glycol, and preferably has a number average molecular weight in the range of 400 to 5,000.

Examples of the unsaturated dibasic acid include maleic acid, maleic anhydride, fumaric acid, itaconic acid, itaconic anhydride and the like. They can be used alone, or combinations of two or more. Examples of the saturated dibasic acid include aromatic dibasic acids, halogenated saturated dibasic acids and the like such as phthalic acid, phthalic anhydride, halogenated phthalic anhydride, isophthalic acid, terephthalic acid, tetrachlorophthalic acid, tetrachlorophthalic anhydride, dimer acids, 2,6-naphthalenedicarboxylic acid, 2,7-naphthalenedicarboxylic acid, 2,3-naphthalenedicarboxylic acid, 2,3-naphthalenedicarboxylic anhydride, 4,4′-biphenyldicarboxylic acid and dialkyl esters thereof. They can be used alone, or combinations of two or more.

In addition, it is necessary that the unsaturated dibasic acid accounts for 70 to 100 mol % (the saturated dibasic acid accounts for 0 to 30 mol %) in the dibasic acid component used in the present invention, and it is preferable that the dibasic acid component consists of an unsaturated dibasic acid. If the ratio of the unsaturated dibasic acid in the dibasic acid component is less than 70 mol %, sufficient alcohol resistance cannot be obtained.

Further, the molar concentration of fumaric acid in the unsaturated acid in the unsaturated polyester is 75% or more, preferably 80% or more. If it is less than the above value, there are cases where ethanol resistance would be reduced. In addition, it has been publicly known that maleic acid and maleic anhydride are converted into fumaric acid in the esterification reaction. Therefore, if the obtained unsaturated polyester satisfies the above molar concentration of fumaric acid, fumaric acid may not be used as a reaction ingredient. In the analysis method of the molar concentration of fumaric acid, the molar concentration can be easily calculated using the integral ratio of the peak of fumaric acid to peaks of other unsaturated acids by a nuclear magnetic resonance (NMR) analysis device.

It is necessary that the polyalcohol component used in the present invention contains 50 to 100 mol % of a glycol having a carbon atom number of 1 to 3 in the main chain and a side chain number of 0 or 1. If the ratio of the above glycol in the polyalcohol component is less than 50 mol %, sufficient alcohol resistance cannot be obtained. Examples of a glycol having a carbon atom number of 1 to 3 in the main chain and a side chain number of 0 or 1 include ethylene glycol, 1,3-propanediol, 1,2-propanediol, 1,3-butanediol, 2-methyl-1,3-propanediol and the like. In particular, it is likely that glycols having a side chain would reduce alcohol resistance, compared to glycols which do not have a side chain. Therefore, it is preferable that the polyalcohol component consist of a glycol which has a carbon atom number of 1 to 3 in the main chain and does not have a side chain.

Other examples of the polyalcohol component include 1,4-butanediol, 1,5-pentanediol, 1,6-hexanediol, 1,2-butanediol, neopentyl glycol, 2-methyl-1,4-butanediol, 2-ethyl-1,4-butanediol, 2,2,4-trimethyl-1,3-pentanediol, 2-ethyl-2-butyl-1,3-propanediol, 3-methyl-1,5-pentanediol, diethylene glycol, triethylene glycol, polyethylene glycol, dipropylene glycol, polypropylene glycol, hydrogenated bisphenol A, cyclohexanedimethanol, adducts of a divalent phenol represented by bisphenol A, bisphenol F, bisphenol S, tetrabromobisphenol A or the like with an alkylene oxide represented by propylene oxide or ethylene oxide, 1,2,3,4-tetrahydroxybutane, glycerin, trimethylolpropane, pentaerythritol, 1,2-cyclohexane glycol, 1,3-cyclohexane glycol, 1,4-cyclohexane glycol, 1,4-cyclohexane dimethanol, paraxylene glycol, bicyclohexyl-4,4′-diol, 2,6-decalin glycol, 2,7-decalin glycol and the like.

As the unsaturated polyester used in the present invention, those modified by a dicyclopentadiene-based compound may be used as long as the effect of the present invention is not reduced. Modification thereof with a dicyclopentadiene-based compound may be performed by various publicly known methods. An example thereof is a method comprising obtaining an adduct product of a dicyclopentadiene with maleic acid (cydecanol monomalate) to be used as the monobasic acid for introduction of a dicyclopentadiene skeleton.

### <Polymerizable Unsaturated Monomer>

The polymerizable unsaturated monomer used in the present invention includes unsaturated monomers and the like capable of crosslinking with the unsaturated polyester. It is preferable that the polymerizable unsaturated monomer has a vinyl group or a (meth)acryloyl group. Specific examples of a monomer having a vinyl group include styrene, p-chlorostyrene, vinyl toluene, α-methylstyrene, dichlorostyrene, divinylbenzene, t-butylstyrene, vinyl acetate, diallyl phthalates, triallyl cyanurate and the like.

Examples of a monomer having a (meth)acryloyl group include acrylic esters, methacrylic esters and the like; methyl (meth)acrylate, ethyl(meth)acrylate, n-butyl(meth)acrylate, i-butyl (meth)acrylate, t-butyl (meth)acrylate, 2-ethylhexyl (meth)acrylate, lauryl (meth)acrylate, cyclohexyl (meth)acrylate, benzyl (meth)acrylate, stearyl (meth)acrylate, tridecyl (meth)acrylate, dicyclopentenyloxyethyl (meth)acrylate, ethylene glycol monomethyl ether (meth)acrylate, ethylene glycol monoethyl ether (meth)acrylate, ethylene glycol monobutyl ether (meth)acrylate, ethylene glycol monohexyl ether (meth)acrylate, ethylene glycol mono-2-ethylhexyl ether (meth)acrylate, diethylene glycol monomethyl ether (meth)acrylate, diethylene glycol monoethyl ether (meth)acrylate, diethylene glycol monobutyl ether (meth)acrylate, diethylene glycol monohexyl ether (meth)acrylate, diethylene glycol mono-2-ethylhexyl ether (meth)acrylate, neopentyl glycol di(meth)acrylate, dimethacrylate of PTMG, 1,3-butylene glycol di(meth)acrylate, 1,6-hexanediol di(meth)acrylate, neopentyl glycol di(meth)acrylate, 2-hydroxy-1,3-dimethacryloxypropane, 2,2-bis[4-(methacryloxyethoxy)phenyl]propane, 2,2-bis[4-(methacyloxy.diethoxy)phenyl]propane, 2,2-bis[4-(methacyloxy.polyethoxy)phenyl]propane, tetraethylene glycol diacrylate, bisphenol AEO modified (n=2) diacrylates, isocyanurate EO modified (n=3) diacrylates, pentaerythritol diacrylate monostearate, various derivatives with dicyclopentadiene, dicyclodecane, triazine or the like, dicyclopentenyl acrylate, dicyclopentenyloxyethyl acrylate, tricyclodecanyl acrylate, tricyclodecanyl methacrylate or tris(2-hydroxyethyl)isocyanuric acrylate and the like.

Further, examples of a polyfunctional (meth)acrylic ester include alkanediol di(meth)acrylates such as ethylene glycol di(meth)acrylate, 1,2-propylene glycol di(meth)acrylate, 1,3-butylene glycol di(meth)acrylate, 1,4-butylene glycol di(meth)acrylate, neopentyl glycol di(meth)acrylate, and 1,6-hexanediol di(meth)acrylate, polyoxyalkylene-glycol di(meth)acrylates such as diethylene glycol di(meth)acrylate, dipropylene glycol di(meth)acrylate, triethylene glycol (meth)acrylate, tetraethylene glycol di(meth)acrylate, polyethylene glycol (meth)acrylate and the like, trimethylolpropane di(meth)acrylate, glycerin di(meth)acrylate, pentaerythritol di(meth)acrylate, trimethylolpropane tri(meth)acrylate, glycerin tri(meth)acrylate, pentaerythritol tri(meth)acrylate, pentaerythritol tetra(meth)acrylate, dipentaerythritol hexa(meth)acrylate, divinylbenzene, diallyl phthalate, triallyl phthalate, triallyl cyanurate, triallyl isocyanurate, allyl (meth)acrylate, diallyl fumarate and the like. They can be used alone, or two or more thereof may be used in combination.

In the unsaturated polyester resin composition (A) of the present invention, the unsaturated polyester accounts for 20 to 80 wt %, and the polymerizable unsaturated monomer accounts for 80 to 20 wt %.

### <Scale-Like Glass>

As the scale-like glass used in the present invention, a publicly known one may be used. However, the scale-like glass preferably has an average thickness of 0.1 to 10 μm and an average particle size of 0.01 to 2 mm, more preferably has a thickness of 1 to 8 μm and an average particle size of 0.05 to 1.7 mm. If the thickness and particle size of the scale-like glass are less than the above values, the ethanol penetration preventive property and strength of the present invention may be insufficient. In addition, if the thickness and the particle size of the scale-like glass are more than the above values, the wettability on the surface of the present invention may be reduced.

Surface treatment should be performed for the scale-like glass so as to make the scale-like glass more compatible with the unsaturated polyester resin. The surface treatment can be performed by a publicly known method, but the treatment with a silane compound such as an aminosilane, a vinylsilane, an epoxysilane, an acrylsilane or the like is preferable.

In view of the corrosion resistance, durability and strength, with respect to 100 parts by weight of the unsaturated polyester resin composition (A), 1 to 100 parts by weight of the scale-like glass is added to the anticorrosive coating composition of the present invention. The scale-like glass preferably accounts for 5 to 80 parts by weight, more preferably 5 to 50 parts by weight, with respect to 100 parts by weight of the unsaturated polyester resin composition (A).

### <Other Components>

Epoxy (meth)acrylate and/or an unsaturated polyester other than the above-described unsaturated polyesters, a thixotropic agent such as silica and the like, a filler such as calcium carbonate, talc and the like, a reinforcing fiber, paraffin wax, a pigment and the like may be added to the anticorrosive coating composition of the present invention such that the effect of the present invention would not be reduced.

The epoxy (meth)acrylate is a product in which an acid group of an unsaturated monobasic acid is added to an epoxy group and is prepared by reacting an epoxy resin having at least two epoxy groups in one molecule with an unsaturated monobasic acid. The epoxy (meth)acrylate is preferably di(meth)acrylate and/or tri(meth)acrylate. The epoxy (meth)acrylate is obtained by reacting an epoxy resin preferably having an average epoxy equivalent in the range of 10 to 500 with an unsaturated monobasic acid in the presence of an esterification catalyst. Representative examples of the epoxy resin include the following compounds.

An epoxy resin having a terminal epoxy group include a reaction product of bisphenol A with epichlorohydrin, a reaction product of bisphenol F with epichlorohydrin, a reaction product of hydrogenated bisphenol A with epichlorohydrin, a reaction product of cyclohexanedimethanol with epichlorohydrin, a reaction product of norbornane dialcohol with epichlorohydrin, a reaction product of tetrabromobisphenol with epichlorohydrin, a reaction product of tricyclodecanedimethanol with epichlorohydrin, a reaction product of phenol novolac with epichlorohydrin, a reaction product of cresol novolac with epichlorohydrin, a reaction product of 1,6-naphthalenediol with epichlorohydrin, epoxy resins having a dicyclopentadiene skeleton, dicyclopentadiene alicyclic diepoxy adipate, alicyclic diepoxy carbonate, alicyclic diepoxy acetal, alicyclic diepoxy carboxylate and the like.

A glycidyl ether type compound in which ethylene oxide and/or propylene oxide is added to the terminal hydroxyl group of a compound having two or more hydroxyl groups is, for example a compound obtained by adding the oxide to a compound having two or more hydroxyl groups and reacting the same with epichlorohydrin. Examples thereof are various glycidyl ether type compounds including a bisphenol A ethylene oxide adduct, a bisphenol A propylene oxide adduct, a bisphenol F ethylene oxide adduct, a bisphenol F propylene oxide adduct, a cyclohexanedimethanol ethylene oxide adduct, a cyclohexanedimethanol propylene oxide adduct, a hydrogenated bisphenol A ethylene oxide adduct, a hydrogenated bisphenol A propylene oxide adduct, a diphenyl ethylene oxide adduct, a diphenyl propylene oxide adduct and the like.

A compound having two or more hydroxyl groups may be used so as to elongate the epoxy group or the like. Specific compounds thereof include bisphenol A, hydrogenated bisphenol A, cyclohexanedimethanol, norbornane dialcohol, tetrabromobisphenol A, tricyclodecanedimethanol, 1,6-naphthalenediol and the like. The above epoxy resin may be used alone, or combinations of two or more such that the properties of the composition are not reduced.

Especially representative examples of the unsaturated monobasic acid used in the preparation of the epoxy (meth)acrylate include acrylic acid, methacrylic acid, cinnamic acid, crotonic acid, sorbic acid, monomethyl malate, monopropyl malate, monobutyl malate and the like. Among them, acrylic acid and methacrylic acid are especially preferable.

These unsaturated monobasic acids may be used alone, or combinations of two or more. The reaction of the above epoxy resin with the unsaturated monobasic acid may be performed by a publicly known method, but it is preferably performed at a temperature within the range of 60 to 140° C., more preferably 80 to 120° C. in the presence of an esterification catalyst. The added amounts of the epoxy resin and the unsaturated monobasic acid are preferably at an equivalent ratio of the acid group to the epoxy group of 0.7 to 1.3/1, more preferably 0.8 to 1.2/1.

As the esterification catalyst, a publicly known and generally used compound may be used. Among them, especially representative compounds include amines such as triethylamine, N,N-dimethylbenzylamine, 2-methylimidazole, N,N-dimethylaniline, diazabicyclooctane and the like, diethylamine hydrochloride, tin, zinc, iron, chromium, vanadium, phosphorus-containing compounds and the like.

In addition, a compound capable of adding a carboxyl group to at least one part of the hydroxyl groups may be reacted with the epoxy (meth)acrylate to introduce the carboxyl group therein. The method for introducing the carboxyl group is not particularly limited, but it is preferable that the hydroxyl group produced by the reaction of the epoxy resin with the unsaturated monobasic acid, namely the hydroxyl group formed by ring-opening reaction of an epoxy group is reacted with an acid anhydride. The reaction is achieved by adding an acid anhydride to epoxy (meth)acrylate or adding an acid anhydride to a mixture of the epoxy(meth)acrylate with the polymerizable unsaturated monomer after the production of the epoxy (meth)acrylate.

Representative specific examples of the acid anhydride which is a preferable compound capable of adding a carboxyl group include maleic anhydride, itaconic anhydride, phthalic anhydride, tetrahydrophthalic anhydride, hexahydrophthalic anhydride, halogenated phthalic anhydride, trimellitic anhydride, 2,3-naphthalenedicarboxylic anhydride and the like. The above acid anhydrides are preferable as the compounds capable of adding a carboxyl group. However, for example, compounds having an isocyanate group and a carboxyl group, compounds having a silyl group and a carboxyl group and the like may be used.

The number average molecular weight of the epoxy (meth)acrylate is preferably in the range of 500 to 3,000. Please note that the number average molecular weight herein means a polystyrene equivalent number average molecular weight obtained by gel permeation chromatography.

In addition, with respect to 100 parts by weight of the above unsaturated polyester (i), 0 to 100 parts by weight of epoxy (meth)acrylate and/or an unsaturated polyester other than the above-described unsaturated polyesters may be added.

Both of the above-described unsaturated polyester and the epoxy (meth)acrylate used in combination, as necessary are generally dissolved using a polymerizable unsaturated monomer and used as a thermoplastic resin composition. The added ratio thereof is such that preferably, in the unsaturated polyester resin composition (A), with respect to 40 to 95 wt % of the total of the above-described unsaturated polyester and the epoxy (meth)acrylate used in combination, as necessary, the polymerizable unsaturated monomer accounts for 5 to 60 wt %.

A polymerization inhibitor can be optionally added to the anticorrosive coating composition of the present invention. The polymerization inhibitor is one publicly known and generally used for unsaturated polyester resins. Example thereof include hydroquinone, trihydrobenzene, benzoquinone, P-benzoquinone, methylhydroquinone, trimethylhydroquinone, hydroquinone monomethyl ether, t-butylhydroquinone, catechol, t-butyl catechol, 2,6-di-t-butyl-4-methylphenol and the like. The polymerization inhibitor can be added to the above unsaturated polyester resin composition (A) in an amount within the range of 10 to 1000 ppm.

It is preferable that thixotropy is imparted to the anticorrosive coating composition of the present invention by adding a thixotropy imparting agent and thixotropy imparting auxiliary agent to the anticorrosive coating composition so as to prevent the sedimentation of the scale-like glass and to improve the coating property of the composition coated on the perpendicular surface. Specific examples of the thixotropy imparting agent include anhydrous fine powdery silica, asbestos, clay, organic bentonite, organic amide wax and the like. In addition, specific examples of the thixotropy imparting auxiliary agent include polyethylene glycol, glycerin, polyhydroxycaboxylic acid amide, organic tertiary ammonium salts, BYK-R-605 (product name: manufactured by BYK Japan KK) and the like. Thixotropy can be imparted to the resin by adding these thixotropy imparting agents. The resin barely droops, and can be uniformly coated on the vertical as well as horizontal surfaces, and thus a uniformly cured film can be formed. These thixotropy imparting agents can be added in an amount of within the range of 0.2 to 10 parts by weight, with respect to 100 parts by weight of the above unsaturated polyester resin composition (A).

A filler such as titanium oxide, calcium carbonate, aluminum hydroxide, fly ash, barium sulfate, talc, clay, glass powder and the like may be used for the anticorrosive coating composition of the present invention. Examples of the aggregate include silica sand, gravel, crushed-stone and the like. The filler or the aggregate can be added in an amount within the range of 1 to 300 parts by weight, with respect to 100 parts by weight of the above unsaturated polyester resin composition (A).

A fibrous reinforcing material other than the scale-like glass may be used, as necessary, for the anticorrosive coating composition of the present invention. Examples of the fibrous reinforcing material to be used include glass fibers, organic fibers of an amide, aramide, vinylon, a polyester, phenol or the like, carbon fibers, and inorganic fibers such as metal fibers, ceramic fibers and the like. They may be used alone, or combinations of two or more. The fibrous reinforcing material preferably accounts for 1 to 300 parts by weight, more preferably 5 to 200 parts by weight, with respect to 100 parts by weight of the unsaturated polyester resin composition (A) of the present invention.

Wax may be added to the anticorrosive coating composition of the present invention. A specific example of wax is at least one wax selected from the group consisting of petroleum-based waxes, olefin-based waxes, polar waxes and special waxes. Examples of petroleum-based waxes include paraffin-based waxes, microcrystalline waxes and the like. Examples of olefin-based waxes include polyethylene, polypropylene and the like. Examples of polar waxes are waxes in which a polar group (a hydroxyl group, an ester group or the like) is introduced into the petroleum-based waxes or the olefin-based waxes, and esters of unsaturated fatty acids such as oleic acid, linoleic acid, linolenic acid or the like. An example of the special wax includes Byk LPS-6665 manufactured by BYK Japan KK. These waxes may be added in an amount in the range of 0.01 to 2 parts by weight, with respect to 100 parts by weight of the above unsaturated polyester resin composition (A). In the use of the waxes, they are precipitated on the surfaces of the coating and a lining layer when the anticorrosive coating composition is cured to effectively function as an oxygen insulating agent, and an excellent surface drying property of the coating and the lining layer can be obtained. (They can prevent curing inhibition and the like caused by air and oxygen on the surface.) If these waxes are not used, there may be cases where it is difficult to obtain excellent surface drying properties.

Colorants such as organic pigments, inorganic pigments, dyes and the like, plasticizers such as chlorinated paraffin, phosphate, phthalate and the like, metal oxide-based thickening agents such as magnesium oxide, calcium oxide, zinc oxide and the like, antifoaming agents such as silicon-based agents, acrylic agents, polymeric agents and the like, and publicly known ultraviolet light absorbing agents including benzotriazoles such as 2(2′-hydroxy-5′-methylphenyl)benzotriazole and the like, benzophenones such as 2,4-dihydroxybenzophenone and the like and benzoates may be used for the anticorrosive coating composition of the present invention as far as the properties of the composition are not reduced. Further, ultraviolet light absorbing agents such as hindered amines and the like may be used. They may be added in an amount in the range of 0.01 to 10 parts by weight, with respect to 100 parts by weight of the above unsaturated polyester resin composition (A).

The anticorrosive coating composition of the present invention can be easily cured at room temperature or by heat by adding a generally used radical curing agent or curing accelerator, or additionally using a photoradical initiator. Organic peroxides may be used as the radical curing agent. Specifically, publicly known and generally used radical curing agents including diacyl peroxide types such as benzoyl peroxide and the like, peroxy ester types such as t-butyl peroxybenzoate and the like, hydroperoxide types such as cumene hydroperoxide and the like, dialkyl peroxide types such as dicumyl peroxide and the like, ketone peroxide types such as methyl ethyl ketone peroxide, acetyl acetone peroxide and the like, peroxyketal types, alkyl perester types, percarbonate types, mixture curing agents such as 328E (manufactured by KAYAKU AKZO CORPORATION), 328EM (manufactured by KAYAKU AKZO CORPORATION) and the like may be used. These radical curing agents may be added in an amount in the range of 0.1 to 6 parts by weight, with respect to 100 parts by weight of the unsaturated polyester resin composition (A).

Examples of the curing accelerator include metal soaps such as cobalt naphthenate, cobalt octylate, zinc octylate, vanadium octylate, copper naphthenate, barium naphthenate and the like, metal chelates such as vanadium acetyl acetate, cobalt acetyl acetate, iron acetyl acetonate and the like, aniline, N,N-substituted anilines such as N,N-dimethylaniline, N,N-diethylaniline, p-toluidine, N,N-dimethyl-p-toluidine, N,N-bis(2-hydroxyethyl)-p-toluidine, 4-(N,N-dimethylamino)benzaldehyde, 4-[N,N-bis(2-hydroxyethyl)amino]benzaldehyde, 4-(N-methyl-N-hydroxyethylamino)benzaldehyde, N,N-bis(2-hydroxypropyl)-p-toluidine, N-ethyl-m-toluidine, triethanolamine, m-toluidine, diethylene triamine, pyridine, phenyl morpholine, piperidine, N,N-bis(hydroxyethyl)aniline, diethanolaniline and the like, amines such as N,N-substituted-p-toluidine, 4-(N,N-substituted amino)benzaldehyde and the like. These curing accelerators may be added in an amount in the range of 0.1 to 5 parts by weight, with respect to 100 parts by weight of the unsaturated polyester resin composition (A).

Photosensitizers may be used as the photoradical initiator. Specific examples thereof include benzoin ether types such as benzoin alkyl ethers and the like, benzophenone types such as benzophenone, benzyl, methyl orthobenzoylbenzoate and the like, acetophenone types such as benzyl dimethylketal, 2,2-diethoxyacetophenone, 2-hydroxy-2-methylpropiophenone, 4-isopropyl-2-hydroxy-2-methylpropiophenone, 1,1-dichloroacetophenone and the like, and a thioxanthone type such as 2-chlorothioxanthone, 2-methylthioxanthone, 2-isopropylthioxanthone and the like. These photoradical initiators may be added in an amount in the range of 0.1 to 6 parts by weight, with respect to 100 parts by weight of the unsaturated polyester resin composition (A).

The anticorrosive coating composition of the present invention exhibits more alcohol resistance than the bisphenol A type vinyl ester-based flake compound, and is economically effective. Therefore, it is extremely useful for situations where alcohol resistance is required.

An example of a method for producing a coating structure of the present invention comprises performing a surface treatment such as sandblasting on a base steel plate, coating a primer using a roller or the like and then coating the anticorrosive coating composition of the present invention. The coating method includes spray coating, and roller coating, but it is not particularly limited. Considering the anticorrosive property of the coating, it is preferable that the thickness of the coating is large, i.e., 200 μm or more obtained by repeating the coating steps. However, the thickness of the coating is not limited.

### EXAMPLES

The details of the present invention will be further explained, with reference to examples. However, the present invention is not limited by the examples. Please note that the analysis of the molar concentration of fumaric acid was performed using a nuclear magnetic resonance apparatus JNM-LA300 FT NMR SYSTEM manufactured by JEOL Ltd. The molar concentration thereof was calculated using the integral ratio of fumaric acid to other unsaturated fatty acids.

### [Preparation of Unsaturated Polyester]

### Synthesis Example 1

3.1 moles of maleic anhydride, 2.2 moles of ethylene glycol and 0.9 mole of 1,5-pentanediol were charged into a four-neck flask equipped with a thermometer, a stirrer, an inert gas inlet and a reflux condenser, the mixture was agitated under a stream of nitrogen by heating to raise the temperature to 200° C. and an esterification reaction was conducted by general procedural techniques. When the acid value became 30.8 mgKOH/g, the mixture was cooled to obtain an unsaturated polyester. The content of fumaric acid was 78 mol %. Next, 0.50 part by weight of hydroquinone was added to the unsaturated polyester, and this was dissolved in styrene to prepare an unsaturated polyester resin composition (PE-1) having a styrene content of 45 wt %.

### Synthesis Example 2

3.3 moles of fumaric acid, 2.3 moles of 1,2-propanediol and 1.0 mole of 1,5-pentanediol were charged into a four-neck flask equipped with a thermometer, a stirrer, an inert gas inlet and a reflux condenser, the mixture was agitated under a stream of nitrogen by heating to raise the temperature to 200° C. and an esterification reaction was conducted by general procedural techniques. When the acid value became 28.6 mgKOH/g, the mixture was cooled to obtain an unsaturated polyester. Next, 0.50 part by weight of hydroquinone was added to this unsaturated polyester to obtain an unsaturated polyester. This was dissolved in styrene to prepare an unsaturated polyester resin composition (PE-2) having a styrene content of 45 wt %.

### Synthesis Example 3

3.2 moles of maleic anhydride, 2.2 moles of 2-methyl-1,3-propanediol and 1.0 mole of 1,5-pentanediol were charged into a four-neck flask equipped with a thermometer, a stirrer, an inert gas inlet and a reflux condenser, the mixture was agitated under a stream of nitrogen by heating to raise the temperature to 200° C. and an esterification reaction was conducted by general procedural techniques. When the acid value became 23.3 mgKOH/g, the mixture was cooled to obtain an unsaturated polyester. Next, 0.50 part by weight of hydroquinone was added to this unsaturated polyester. The content of fumaric acid was 85 mol %. This was dissolved in styrene to prepare an unsaturated polyester resin composition (PE-3) having a styrene content of 45 wt %.

### Synthesis Example 4

0.9 mole of isophthalic acid, 2.2 moles of 1,2-propylene glycol and 0.9 mole of 1,5-pentanediol were charged into a four-neck flask equipped with a thermometer, a stirrer, an inert gas inlet and a reflux condenser, the mixture was agitated under a stream of nitrogen by heating to raise the temperature to 190° C. and then the mixture was gradually heated to 215° C. to conduct an esterification reaction. When the acid value became 9.5 mgKOH/g, the mixture was cooled. 2.2 moles of fumaric acid was charged into the flask at 120° C., and an esterification reaction was conducted at a temperature from 150 to 210° C. by general procedural techniques. When the acid value became 9.8 mgKOH/g, the mixture was cooled to obtain an unsaturated polyester. Next, 0.50 part by weight of hydroquinone was added to this unsaturated polyester. This was dissolved in styrene to prepare an unsaturated polyester resin composition (PE-4) having a styrene content of 45 wt %.

### Comparative Synthesis Example 1

0.7 mole of maleic anhydride, 0.7 mole of fumaric acid and 1.4 moles of an adduct of divalent phenol of bisphenol A with propylene oxide were charged into a four-neck flask equipped with a thermometer, a stirrer, an inert gas inlet and a reflux condenser, the mixture was agitated under a stream of nitrogen by heating to raise the temperature to 200° C. and an esterification reaction was conducted by general procedural techniques. When the acid value became 9.8 mgKOH/g, the mixture was cooled to obtain an unsaturated polyester. Next, 0.50 part by weight of hydroquinone was added to this unsaturated polyester. The content of fumaric acid was 93 mol %. This was dissolved in styrene to prepare an unsaturated polyester resin composition (PE-5) having a styrene content of 45 wt %.

### Comparative Synthesis Example 2

0.8 mole of isophthalic acid, 1.0 mole of 1,2-propanediol and 1.8 moles of neopentyl glycol were charged into a four-neck flask equipped with a thermometer, a stirrer, an inert gas inlet and a reflux condenser, the mixture was agitated under a stream of nitrogen by heating to raise the temperature to 190° C. and then the mixture was gradually heated to 215° C. to conduct an esterification reaction. When the acid value became 9.5 mgKOH/g, the mixture was cooled. 2.0 moles of maleic anhydride was charged into the flask at 120° C., and an esterification reaction was conducted at a temperature from 150 to 210° C. by general procedural techniques. When the acid value became 9.8 mgKOH/g, the mixture was cooled to obtain an unsaturated polyester. Next, 0.50 part by weight of hydroquinone was added to this unsaturated polyester. The content of fumaric acid was mol %. This was dissolved in styrene to prepare an unsaturated polyester resin composition (PE-6) having a styrene content of 45 wt %.

### Comparative Synthesis Example 3

378 g of a bisphenol A type epoxy resin (ARALDITE AER-2603: manufactured by ASAHI KASEI EPOXY CO., LTD., having an epoxy equivalent of 189) was charged into a four-neck flask equipped with a thermometer, a stirrer, an inert gas inlet and a reflux condenser, the mixture was heated to 100° C. while was agitated. Next, 0.27 g of methylhydroquinone, 172 g of methacryl acid and 1.65 g of 2,4,6-tris(dimethylaminomethyl)phenol (SEIKUOL TDMP) were charged into the flask, and the mixture was heated while being agitated to conduct an esterification reaction at a temperature of 120 to 130° C. by general procedural techniques. When the acid value became 15 mgKOH/g, the mixture was cooled, and 450 g of a styrene monomer was added to prepare a bisphenol A type vinyl ester resin (VE-1) having a styrene content of 45 wt %.

### <Evaluation of Ethanol Resistance>

Ripoxy R-804BDA RED (manufactured by SHOWA HIGHPOLYMER CO., LTD.; a primer for metals) was coated on the entire surface of a 5 cm×10 cm×5 mm sandblasted iron plates. After the primer was cured, Synthesis Examples 1 to 4 and Comparative Synthesis Examples 1 to 3 which were formulated to have a composition in Table 2 were coated over the entire surfaces thereof such that the thickness of the coated layer was about 1 mm. After being cured at 23° C. for one week, the laminates were immersed in ethanol in a room at a constant temperature of 23° C. The test pieces were removed from the ethanol after three months. The appearances thereof were observed, and the ratio of weight change and the ratio of thickness change were determined.

The appearances thereof were visually observed. Test pieces without a defect were evaluated as O, test pieces with defects such as a certain level of whitening were evaluated as Δ, and test pieces with defects such as whitening were evaluated x.

The thicknesses of ten portions of the coating of a test piece were measured using an electromagnetic coating thickness meter UNIBOY-M manufactured by SANKO ELECTRONIC LABORATORY CO., LTD. to obtain an average thickness as a thickness of the coating of the test piece. The ratio of thickness change was calculated using the following equation. The results thereof are shown in Table 2.

Ratio of thickness change(%)={(thickness of coating of test piece immersed in ethanol for three months)−(thickness of coating of test piece before test piece subjected to immersing step)}/(thickness of coating of test piece before test piece subjected to immersing step)×100 [mathematical formula 1]

As is clear from the results shown in Tables 1 and 2, the ethanol resistance of the anticorrosive coating compositions comprising unsaturated polyesters of Examples 1 to 5 was higher than that of the unsaturated polyester type anticorrosive coatings of Comparative Examples 1 to 4 and the vinyl ester type anticorrosive coating of Comparative Example 5.

TABLE 1

| | | | | | Comparative | Comparative | Comparative |
|---|---|---|---|---|---|---|---|
| | Synthesis | Synthesis | Synthesis | Synthesis | Synthesis | Synthesis | Synthesis |
| | Example 1 | Example 2 | Example 3 | Example 4 | Example 1 | Example 2 | Example 3 |
| Resin Composition Type | PE-1 | PE-2 | PE-3 | PE-4 | PE-5 | PE-6 | VE-1 |
| Mol % of unsaturated dibasic | 100 | 100 | 100 | 71 | 100 | 71.4 | — |
| acid in dibasic acid | | | | | | | |
| component | | | | | | | |
| Mol % of a glycol having a | 71 | 69.7 | 68.8 | 71 | 0 | 35.7 | — |
| carbon atom number of 1 to 3 | | | | | | | |
| in the main chain and a side | | | | | | | |
| chain number of 0 or 1 in the | | | | | | | |
| polyalcohol component | | | | | | | |

TABLE 2

| | | | | | | Compar. | Compar. | Compar. | Compar. | Compar. |
|---|---|---|---|---|---|---|---|---|---|---|
| | Example 1 | Example 2 | Example 3 | Example 4 | Example 5 | Example 1 | Example 2 | Example 3 | Example 4 | Example 5 |
| PE-1 | 100 | | | 100 | | | | | | |
| PE-2 | | 100 | | | | | | | | |
| PE-3 | | | 100 | | | | | | | |
| PE-4 | | | | | 100 | | | | | |
| PE-5 | | | | | | 100 | | | | 100 |
| PE-6 | | | | | | | 100 | | | |
| VE-1 | | | | | | | | 100 | 100 | |
| TALEN | 4.0 | 4.0 | 4.0 | 4.0 | 4.0 | 4.0 | 4.0 | 4.0 | 4.0 | 4.0 |
| 7200-20 | | | | | | | | | | |
| RCF-160 | 25 | 25 | 10 | 50 | 25 | 25 | 10 | 25 | 50 | |
| Mica | | | | | | | | | | 50 |
| KBM-503 | 0.5 | 0.5 | 0.5 | 0.5 | 0.5 | 0.5 | 0.5 | 0.5 | 0.5 | 0.5 |
| Paraffin | 1.0 | 1.0 | 1.0 | 1.0 | 1.0 | 1.0 | 1.0 | 1.0 | 1.0 | 1.0 |
| 125° F. | | | | | | | | | | |
| 328EM | 1.0 | 1.0 | 1.0 | 1.0 | 1.0 | 1.0 | 1.0 | 1.0 | 1.0 | 1.0 |
| Cobalt | 0.5 | 0.5 | 0.5 | 0.5 | 0.5 | 0.5 | 0.5 | 0.5 | 0.5 | 0.5 |
| naphthenate | | | | | | | | | | |
| Ratio of | 0.12 | 0.14 | 0.20 | 0.10 | 0.12 | 0.32 | 0.31 | 0.39 | 0.30 | 0.40 |
| weight | | | | | | | | | | |
| change (%) | | | | | | | | | | |
| Ratio of | 2.2 | 2.1 | 2.3 | 2.0 | 2.0 | 3.4 | 3.5 | 8.2 | 8.0 | 5.0 |
| thickness | | | | | | | | | | |
| change (%) | | | | | | | | | | |
| Appearance | ∘ | ∘ | ∘ | ∘ | ∘ | Δ | Δ | x | x | Δ |
| change | | | | | | | | | | |

TALEN 7200-20: organic thixotropic agent manufactured by KYOEISHA CHEMICAL CO., LTD.
RCF-160: Glass flakes having average thickness of 5 μm manufactured by NIPPON SHEET GLASS CO., LTD.
Mica having average particle size of 42 μm
KBM-503: silane coupling agent manufactured by SHIN-ETSU CHEMICAL CO., LTD.
Paraffin 125° F.: paraffin wax manufactured by NIPPON SEIRO CO., LTD.
328EM: peroxide manufactured by KAYAKU AKZO CORPORATION

1. An anticorrosive coating composition comprising:
(A) an unsaturated polyester resin composition comprising (i) an unsaturated polyester obtained from a dibasic acid component and a polyalcohol component and (ii) a polymerizable unsaturated monomer; and
(B) a scale-like glass,
wherein the dibasic acid component comprises 70 to 100 mol % of an unsaturated dibasic acid and 0 to 30 mol % of a saturated dibasic acid, and the polyalcohol component comprises 50 to 100 mol % of a glycol having a carbon atom number of 1 to 3 the main chain and a side chain number of 0 or 1.

2. The anticorrosive coating composition according to claim 1, wherein the anticorrosive coating composition is an anticorrosive coating composition for use where alcohol resistance is required.

3. The anticorrosive coating composition according to claim 1, wherein the polyalcohol component comprises a glycol which does not contain an ether bond.

4. The anticorrosive coating composition according to claim 1, wherein the dibasic acid component consists of an unsaturated dibasic acid.

5. The anticorrosive coating composition according to claim 1, wherein the scale-like glass (B) accounts for 1 to 100 parts by weight, with respect to 100 parts by weight of the unsaturated polyester resin composition (A).

6. The anticorrosive coating composition according to claim 1, wherein the average thickness of the scale-like glass is 0.1 to 10 μm, and the average particle size thereof is 10 to 2000 μm.

7. An anticorrosive coating structure obtained by curing the anticorrosive coating composition according to claim 1 on an undercoat selected from the group consisting of concrete, asphalt concrete, mortar, wood and metals.

8. The anticorrosive coating composition according to claim 2, wherein the polyalcohol component comprises a glycol which does not contain an ether bond.
